(19) United States
(12) Patent Application Publication
(10) Pub. No.: US 2012/0208039 A1
(43) Pub. Date: Aug. 16, 2012

(54) MULTILAYER FILM OF A WALL OF A BAG HAVING SEAMS AND INTENDED FOR A BIOPHARMACEUTICAL PRODUCT

(75) Inventors: Magali Barbaroux, La Destrousse (FR); Eric Chevalier, Marseille (FR); Steve Wasterlain, Houdeng-Goegnies Hainaut (BE)

(73) Assignee: SARTORIUS STEDIM BIOTECH S.A., AUBAGNE (FR)

(21) Appl. No.: 13/501,912

(22) PCT Filed: Oct. 29, 2010
(86) PCT No.: PCT/FR10/52336

§ 371 Date: Apr. 13, 2012

(30) Foreign Application Priority Data
Oct. 29, 2009 (FR) 0957610

(51) Int. Cl. B32B 37/18; B32B 27/08; B29C 47/06

(52) U.S. Cl. 428/516; 156/324.4; 264/173.12; 156/501

(57) ABSTRACT

Monolayer contact film, designed, once made integral with a multilayer functional film, to constitute a final multilayer film of a pouch wall; the pouch having seams, and designed to be filled with biopharmaceutical product, and composed of a selected material that can be part of the composition of the final multilayer film, be in contact with the biopharmaceutical product, without degradation of the film and biopharmaceutical product, be sealable on itself, with a thickness that is less than the thickness of a single contact layer of the final multilayer film suitable for the production of seams of the single contact layer on itself, of which one surface functions as an interface for interlocking with a first interface for making the multilayer functional film integral, and whose other surface has as its final function to constitute the contact surface of the final multilayer film with the biopharmaceutical product.

The invention relates to the process for manufacturing and for the composition of multilayer films of a wall of a pouch of the type of pouches comprising seams and specially designed to be filled with biopharmaceutical products.

The object of the invention is more particularly a monolayer contact film that is specially designed to be joined to a multilayer functional film; the application of a selected material to the composition of such a monolayer contact film; a multilayer functional film that is specially designed to be joined to the monolayer contact film; the process for manufacturing a final multilayer film of a pouch wall starting from a monolayer contact film and a multilayer functional film; a final multilayer film that is made according to this process and that comprises a monolayer contact film and a multilayer functional film; a pouch that comprises a wall that forms an envelope consisting of such a final multilayer film; and, finally, an arrangement of a structure for manufacturing a number of final multilayer films of a pouch wall that comprises such a contact film and such a multilayer functional film.

Biopharmaceutical product is defined here as a product that is obtained from biotechnology—culture media, cellular cultures, buffer solutions, artificial nutrition liquids, blood products and derivatives of blood products—or a pharmaceutical product, or more generally a product that is designed to be used in the medical field.

For the purposes of processing or preservation of such a biopharmaceutical product, a process is known that consists in placing it in a pouch that is part of a device that is specially designed for this purpose. Such a device comprises the pouch in question, and at least one functional element, including at least one port (inlet or outlet), and, if necessary, one or more devices for mixing, aeration . . . .

Such pouches are known whose two large walls are sealed to one another. Once expanded, they have a limited volume and remain relatively thin, which justifies the fact that they are often called 2D pouches (D meaning dimensions). 3D pouches are also known that comprise two end walls and a side wall that can be folded flat or deployed unfolded, sealed to one another, with the volume able to reach 3,000 liters, and even more. Such 3D pouches are described in the document WO00/04131 or are marketed by the company Sartorius under the trademark FLEXEL® 3D. The walls of the pouches comprise seams, at least on themselves and on the at least one functional element.

The walls of the pouches are essentially continuous collectively and comprise an outside surface that is in contact with the outside environment of the pouch and an inside surface with which the pharmaceutical product that fills the pouch is in contact.

Such a pouch wall is to have a barrier property with a high degree of sealing against gases. Because of its sturdiness, it is to be able mechanically to contain the biopharmaceutical product that is inside the pouch, whose volume can be more or less significant. It is also to be of a nature to prevent undesirable interactions with the environment or the biopharmaceutical product, for example during the manufacturing, transport or storage. It is to be clean, in particular as regards particles or from the biological standpoint. It is to be non-degradable and to have a high chemical strength. It is also to be able to make it possible that the processing or the preservation of the biopharmaceutical product is reliably ensured. It is to be able to be sealed, as indicated above. It is to be able to be folded and unfolded easily and without deterioration. It is to have qualities as regards in particular adhesion, flexibility, opacity or, in contrast, transparency, with these characteristics in no way excluding others. Finally, the supplying of the pouches is to be able to be ensured in terms of time, quantity and quality, which means that the films that constitute walls are themselves available in terms of time, quantity and quality. This requirement requires resorting to a limited number of technologies and operations, starting from components that can be combined easily according to the required structures. It also requires avoiding bottlenecks of supply, logistics and manufacturing. It also requires that the manufacturer of the pouch closely monitor the key points of the process leading to the processing of the pouch.

It is known that such a pouch wall is made from a multilayer film, called “final multilayer film” or “final film” interchangeably here. Such a film combines several layers of materials that are selected to fulfill the different expected requirements of the final multilayer film. These layers are made integral with one another, by lamination or co-extrusion.

The end user of such a final multilayer film is most often very concerned with the long-term safety of his supplying. He desires to be able to monitor the resins from which the films are manufactured, but also the process for manufacturing the film.

In addition, the end user desires to optimize the costs and the technological platforms. He desires to limit the validation operations made necessary for any new final multilayer film structure, in particular any new structure in which the layer in contact with the biopharmaceutical product is modified.

Finally, the end user desires to have available films that are suitable for increasingly high requirements of flexibility relative to the structure of the final multilayer film, the importance of manufactured series, and also suitable for the design requirements of the pouches, within the framework of a limited number of technological platforms and the constraints indicated above.

Actually, as far as the use of pouches for the biopharmaceutical field is concerned, there is a requirement for variety based in particular on the biopharmaceutical product (nature, processing, preservation conditions, . . . ), characteristics of the pouch (capacity, shape, conditions of use, applications carried out using the pouch (storage, mixing, bioreaction, . . . ) . . . ). This variety cannot be achieved starting from the one and only final multilayer film structure, at least under acceptable economic conditions. It is therefore necessary to provide a wide variety of final multilayer films so as to be able to respond to the great adaptability of desired uses.

The document U.S. Pat. No. 6,361,843 describes a particular structure of a final multilayer film, forming an entity per se, comprising a central layer, an inside contact layer and an outside layer, each made of a selected material, and two connecting layers that ensure the connection between the central layer and, on the one hand, the inside contact layer and, on the other hand, the outside layer. Such a final multilayer film is made by co-extrusion.

The document U.S. Pat. No. 5,164,258 describes an analogous structure that is produced by co-extrusion or lamination.

Such particular structures do not make possible the adaptability of desired uses, which can only be satisfied by using as many particular structures as particular uses envisioned, with all of the drawbacks that result therefrom: necessity for manufacturing, storing, transporting and managing an extended range of films, risk of breaking the film supply chain, cost, and lack of flexibility. In addition, each particular structure, as a finished product that is provided to the end client being different from the others, requires being tested and approved, even if the inside layer for contact with the biopharmaceutical product is always the same.

The document EP-A-0698487 proposes the use of a multilayer airtight membrane that has as its innermost layer a first layer that consists of at least one resin, such as low-density polyethylene or polypropylene, a third layer made of ethylene alcohol and vinyl copolymer being stratified onto the outer side of the first layer, and a second layer being used as an adhesive layer between the first and third layers, so as to prevent the contaminants from migrating from the outside of the third layer to the first layer. If necessary, a fourth and a fifth layer are provided.

The document EP-A-2 100 729 describes a multilayer film for the production of a pouch of medicinal products having an outside layer, a sealable inside layer, and co-extruded intermediate layers.

The document FR-A-2 828 435 relates to the field of the food-processing industry and focuses on capping small containers and on packaging where the products to be packaged are inserted into a tunnel formed by the film, which is then sealed transversely, cut into sections, and then optionally retracted. It describes the production of a multilayer film that consists of a first film that is oriented and not stabilized thermally and a second non-oriented sealing film that are joined together by lamination.

The document JP 1996-492506 relates to a pouch for medicinal liquids that comprises, on the one hand, a multilayer film that is made by lamination of a plastic layer, a resin layer, and a PE or PP layer, and, on the other hand, a sealable PE or PP monolayer film that is attached by fusion to the PE or PP layer of the multilayer film.

The document US-A-2009/0061061 relates to a multilayer film that has oxygen-barrier functions.

The documents CA-A-2 264 463, WO-A-2007/121590, EP-A-0 859 025, DE-A-103 26 498, US-A-2003/096128, JP-A-59 078817 and JP-A-8277335 relate to monolayer films that can be part of the composition of multilayer films of pouch walls.

The invention relates to the framework of pouches that comprise seams and are designed to be filled with biopharmaceutical product. In this framework, the problem on which the invention is based is to meet the requirements presented above relative to the functionality of the final multilayer film, the flexibility and the adaptability with a limited number of films or raw materials, the safety for the supplying, the monitoring of the final multilayer film, and its manufacturing process, and cost.

The solution provided rests on the inventive concept consisting in joining and making integral—in this case by lamination—a monolayer contact film and a multilayer functional film, prepared in advance.

The monolayer contact film is:
Composed of a selected material that can:
   Be part of the composition of a final multilayer film of a pouch wall,
   Be in contact with the biopharmaceutical product, without degradation of the film and biopharmaceutical product,
   Be sealable on itself,
With a thickness that is less than the thickness of a single contact layer—for example of a final multilayer film—of a pouch wall that is suitable for the production of seams of the single contact layer on itself,
Of which one of the surfaces has as its function to be an interface for interlocking with a first interface for making the multilayer functional film integral,
Of which the other surface has as its final function to constitute the contact surface of the final multilayer film with the biopharmaceutical product.

The constituent material of the monolayer contact layer is selected from the family that comprises polyethylene (PE) and in particular linear low-density polyethylene (LLDPE), polyethylene vinyl acetate (EVA), polypropylene (PP), ethylene tetrafluoroethylene (ETFE), polyvinylidene fluoride (PVDF) and equivalent materials, within the framework of the application that is being considered.

The multilayer functional film:
Comprises at least one layer based on the same material as the monolayer contact film and with a thickness that is less than the thickness of a single contact layer—for example, a final multilayer film—of a pouch wall that is suitable for the production of seams of the single contact layer on itself,
   Of which one of the surfaces has as its function to be the first interface for interlocking with the interface for making the monolayer contact film integral or another multilayer functional film with a structure that may or may not be identical,
   Of which the other surface has as its function to be a second interface for interlocking with an interface for making an adjacent functional layer integral,
And comprises at least one functional layer including at least one gas-barrier layer that is non-degradable by itself or in combination with a protective layer.

In the embodiments being considered, the multilayer functional film comprises a number of superposed functional layers, selected for their function of flexibility, sturdiness, handling, opacity or, in contrast, transparency.

The constituent materials of the functional layers are selected from the family that comprises polyethylene (PE), and in particular linear low-density polyethylene (LLDPE) or polyethylene terephthalate (PET), a polyamide (PA), polyethylene vinyl acetate (EVA), ethylene vinyl alcohol (EVOH), styrene ethylene butadiene styrene (SEBS), polyethylene terephthalate glycol (PETG), polyvinylidene fluoride (PVDF) or else aluminum and the equivalent materials, within the framework of the application that is being considered.

Functional layers—or aggregations of functional layers—made of such materials are joined in any suitable manner, depending on the materials that are used, such as co-extrusion or lamination, if necessary with the presence of a suitable connection and combination interface layer.

The process for manufacturing a final multilayer film of a pouch wall is such that:
On the one hand, a monolayer contact film is manufactured or is available,
On the other hand, a multilayer functional film is manufactured or is available,
And the monolayer contact film and the multilayer functional film are made integral, with one of the surfaces of the monolayer contact film forming an interface being made integral with the outside surface of the base layer of the multilayer functional film—of the same material as the monolayer contact film—forming the first interface by lamination.

More particularly, the process for manufacturing a final multilayer film of a pouch wall—pouch comprising seams at least on itself and designed to be filled with biopharmaceutical product—is such that:

On the one hand, a monolayer contact film is manufactured or is available:
And said film consists of a selected material that can:
   Be part of the composition of the final multilayer film of a pouch wall,
   Be in contact with the biopharmaceutical product, without degradation of the film and the biopharmaceutical product,
   Be sealable on itself,
With a thickness that is less than the thickness of a single contact layer of the final multilayer film of a pouch wall that is suitable for the production of seams of the single contact layer on itself,
Of which one of the surfaces has as its function to be an interface for interlocking with a first interface for making the multilayer functional film integral,
Of which the other surface has as its final function to constitute the contact surface of the final multilayer film with the biopharmaceutical product;

On the other hand, a multilayer functional film is manufactured or is available:
And said film comprises at least one base layer of the same material as the monolayer contact film or a material that can be joined to that of the monolayer contact film by lamination,
And with a thickness that is less than the thickness of a single contact layer of the final multilayer film of a pouch wall that is suitable for the production of seams of the single contact layer on itself,
   Of which one of the surfaces has as its function to be the first interface for interlocking with the interface for making the monolayer contact film integral or with a first interface of another multilayer functional film that may or may not have an identical structure,
   Of which the other surface has as its function to be a second interface for interlocking with an interface for making an adjacent functional layer integral,
And comprises at least one functional layer including at least one gas-barrier layer that is non-degradable by itself or in combination with a protective layer;

And the monolayer contact film and the multilayer functional film are made integral, with one of the surfaces of the monolayer contact film forming an interface being made integral in contact with the outside surface of the base layer of the multilayer functional film.

According to one embodiment, a base layer of the same material as that of the monolayer contact film is selected.

According to one embodiment, the monolayer contact film and the multilayer functional film are made integral by lamination.

According to one embodiment, the final multilayer film comprises a material that is selected for being in contact with the biopharmaceutical product, without degradation of the film and biopharmaceutical product, and to be sealable on itself, in two laminated layers that belong to the monolayer contact film and the intermediate multilayer film.

According to one embodiment, the constituent material of the monolayer contact film is selected from the family that comprises polyethylene (PE) and in particular linear low-density polyethylene (LLDPE), polyethylene vinyl acetate (EVA), polypropylene (PP), ethylene tetrafluoroethylene (ETFE), and polyvinylidene fluoride (PVDF).

According to one embodiment, the thickness of the monolayer contact film is less than 150 microns.

According to one embodiment, the multilayer functional film comprises a number of superposed functional layers, each made integral with the adjacent layer(s).

According to one embodiment, the functional layers are selected for their function of flexibility, sturdiness, handling, opacity or, in contrast, transparency.

According to one embodiment, the constituent materials of the functional layer(s) are selected from the family that comprises polyethylene (PE) and in particular linear low-density polyethylene (LLDPE) or polyethylene terephthalate (PET), a polyamide (PA), polyethylene vinyl acetate (EVA), ethylene vinyl alcohol (EVOH), styrene ethylene butadiene styrene (SEBS), polyethylene terephthalate glycol (PETG . . . ), polyvinylidene fluoride (PVDF), or else aluminum and the equivalent materials, within the framework of the application that is being considered.

According to one embodiment, the layers—or aggregations of layers—of the multilayer functional film are joined, depending on the materials that are used, by co-extrusion or lamination.

According to one embodiment, the multilayer functional film is formed by several multilayer functional sub-films that each has the structural characteristics of a multilayer functional film.

According to one embodiment, the multilayer functional film comprises, joined to a base layer of LLDPE, an EVOH layer, a PA layer, and a PET layer that constitutes the outside layer of the multilayer functional film once joined to the monolayer LLDPE film.

According to one embodiment, the multilayer functional film comprises—joined to a base layer of LLDPE—a PE layer.

According to one embodiment, the multilayer functional film comprises—joined to an LLDPE base layer—an EVOH layer, a PA layer, two LLDPE layers, and a layer made of biodegradable material that constitutes the outside layer of the multilayer functional film.

According to one embodiment, the multilayer functional film comprises—joined to an LLDPE base layer—a layer made of biodegradable material, two LLDPE layers, an EVOH layer, and a PA layer that constitutes the outside layer of the multilayer functional film.

According to one embodiment, the multilayer functional film comprises—joined to an LLDPE base layer—an aluminum layer that constitutes the outside layer of the multilayer functional film.

According to one embodiment, the multilayer functional film comprises—joined to an LLDPE base layer—an aluminum layer, two LLDPE layers, and a PEEK layer that constitutes the outside layer of the multilayer functional film.

According to one embodiment, the multilayer functional film comprises—joined to a PE base layer—an EVA layer, an EVOH layer, an EVA layer, and a PE layer that constitutes the outside layer of the multilayer functional film.

According to one embodiment, the multilayer functional film comprises—joined to an LLDPE base layer—an EVOH layer, an LLDPE layer, and a PE layer that constitutes the outside layer of the multilayer functional film.

The invention therefore also relates to the final multilayer film of a pouch wall—with the pouch comprising seams (3) at least on itself and designed to be filled with biopharmaceutical product—comprising a monolayer contact film, a multilayer functional film, with the monolayer contact film and the multilayer functional film being made integral with one another.

The final multilayer film of a wall manufactured by this process consequently comprises a material that is selected to be in contact with the biopharmaceutical product, without degradation of the film and the biopharmaceutical product, and to be sealable to itself, and to be in two laminated layers that belong to the monolayer contact film and to the multilayer functional film.

The invention also relates to a pouch of the type that comprises a wall that forms an envelope and seals at least on itself, designed to be filled with biopharmaceutical product, characterized by the fact that the wall is a final multilayer film.

Relative to the pouch, the contact surface of its wall with the biopharmaceutical product is the free surface of the monolayer contact film.

According to another aspect, the invention has as its object an arrangement of a structure for manufacturing a number of final multilayer films with a pouch wall as they have been described, which comprises:
At least one site for manufacturing contact film, in which at least one monolayer contact film is manufactured,
At least one site for manufacturing functional film, in which a number of multilayer functional films are manufactured,
At least one site for making contact film-functional film integral, in which the monolayer contact film that is manufactured in a site for manufacturing contact film and the multilayer functional film manufactured in a site for manufacturing functional film are made integral with one another.

According to one embodiment, the arrangement comprises at least one site for manufacturing a functional film layer, in which there is manufactured at least one layer of a functional film, functionally combined with at least one site for manufacturing a functional film that comprises this layer. As appropriate, a site for manufacturing the layer of functional film and a site for manufacturing functional film are the same or different.

According to the embodiments, a site for manufacturing contact film and a site for making contact film-functional film integral are the same or different.

According to one characteristic, a site for manufacturing a layer of functional film or a site for manufacturing functional film comprises at least one unit for extrusion, blowing extrusion, co-extrusion, and lamination.

According to one characteristic, a site for making contact film-functional film integral comprises at least one film lamination unit.

According to one characteristic, the arrangement also comprises at least one site for manufacturing pouches from a final multilayer film. In particular, a site for making contact film-functional film integral and a site for manufacturing pouches from a final multilayer film are the same.

Several embodiments of the invention will now be described using drawings, in which:

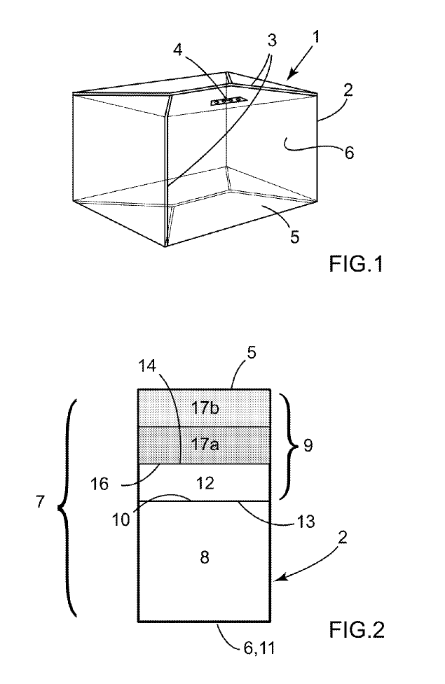

FIG. 1 is a perspective view of a pouch for which a final multilayer film of a wall is designed.

FIG. 2 is a cutaway view of a final multilayer film of a pouch wall according to a symbolic representation.

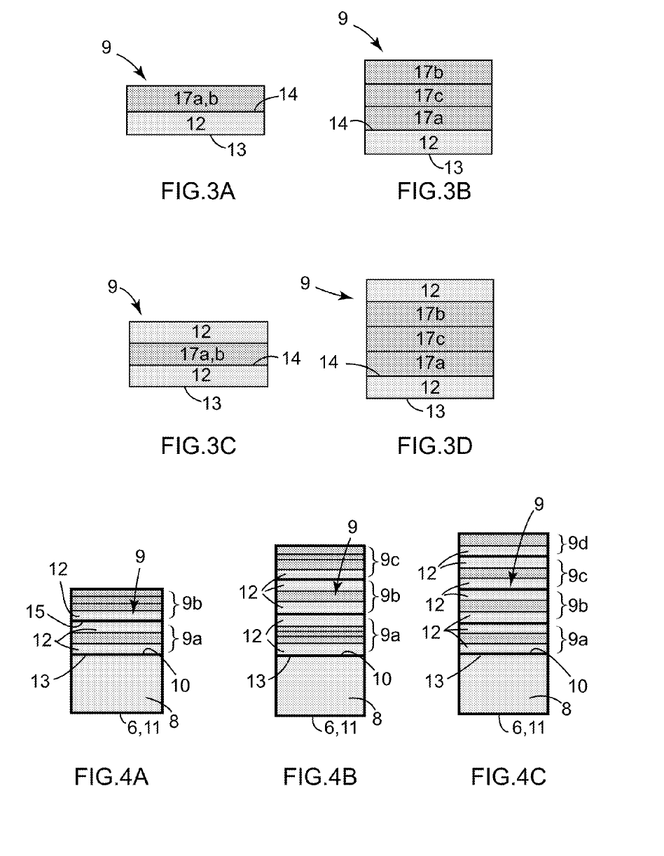

FIGS. 3A, 3B, 3C, and 3D are four cutaway views that illustrate different embodiments of multilayer functional films.

FIGS. 4A, 4B and 4C are three cutaway diagrams of different variants of final multilayer films, with the multilayer functional films being formed by several multilayer functional sub-films.

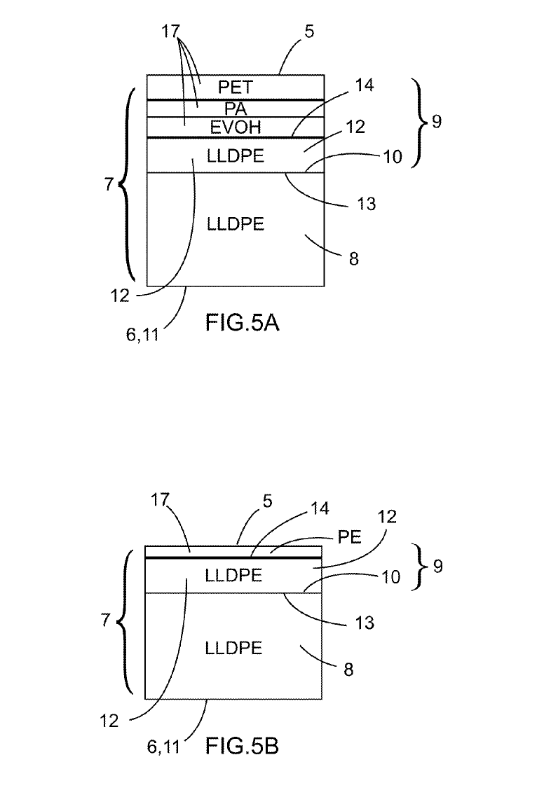

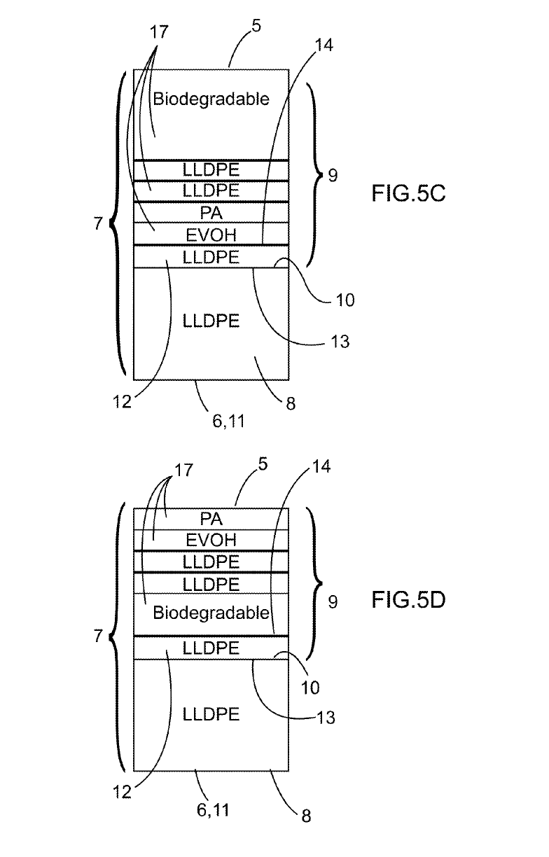

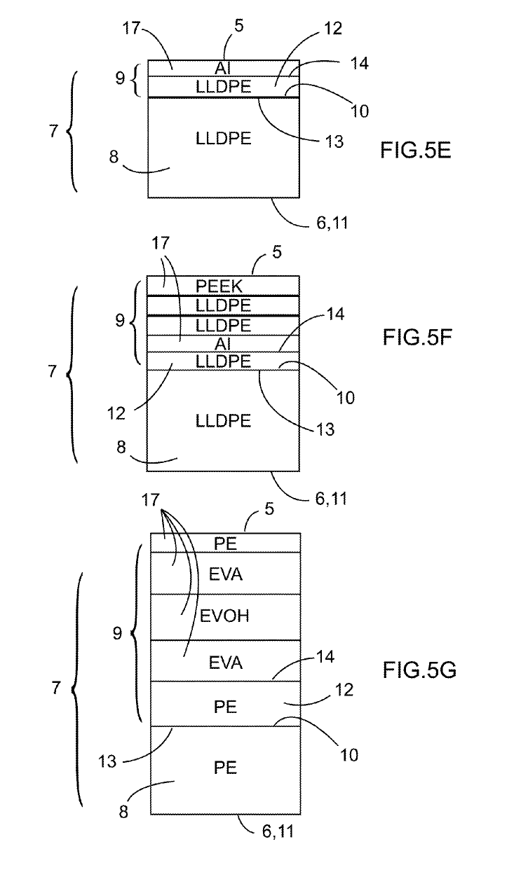

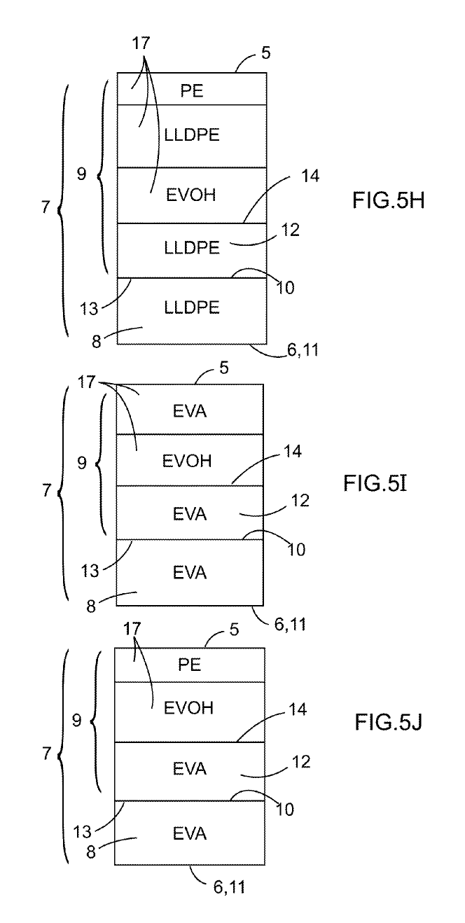

FIGS. 5A to 5J are ten cutaway diagrams of different variants of final multilayer films.

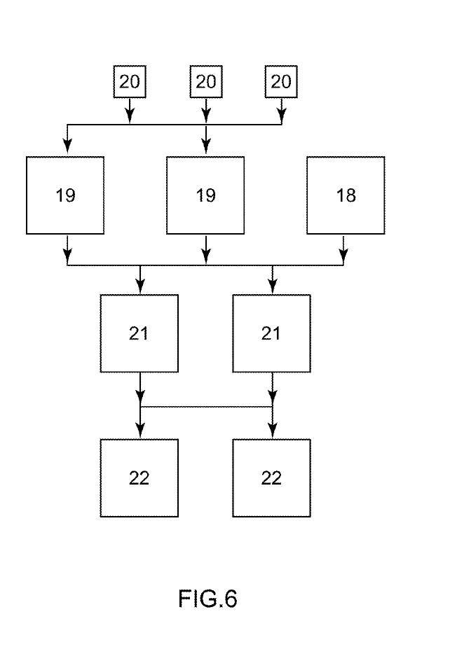

FIG. 6 is a diagrammatic view of an arrangement of a structure for manufacturing a number of final multilayer films of a pouch wall.

One pouch 1 such as the one involved here is of the type that comprises a continuous wall 2, forming an envelope, and seams 3 of the wall 2 on itself to close it, or at the location of one—or more—functional element(s) 4, including at least one port (inlet or outlet), and, if necessary, one or more devices for mixing, aeration . . . .

Such a pouch 1 is designed to be filled with biopharmaceutical product for the preparation, the preservation, the transport or the use of this product.

The wall 2 has an outside surface 5 that is in contact with the outside environment of the pouch 1, and an inside surface 6, with which the pharmaceutical product that fills the pouch 1 is in contact.

This pouch 1 may be a 2D pouch or a 3D pouch.

The wall 2 is made of a final multilayer film 7. This film is described as final because, as such, it constitutes the wall 2, and this in contrast to the monolayer contact film 8 and the multilayer functional film 9 that are integrated into the final film 7 and that can thus be described as intermediate. Thus, the terms “final” and “intermediate” are to be understood to relate to the degree of progress in the processing of the film 7 that is used to constitute the wall 2 of the pouch 1.

Such a final multilayer film 7 comprises several layers that are superposed and each joined to the one or both layers to which it is adjacent, each of these layers being made of a material that is selected for the properties that it has and that are desired for the final multilayer film.

The term “superposed” applied to two layers (or aggregations of layers), like the term “superposition,” is to be understood as meaning that these layers (or aggregations of layers) are placed on one another directly or by means of, if necessary, a connecting interface layer, without restriction where the layers (or aggregations of layers) are located above or below the other, with the position in the space of the unit formed by these two layers being a priori of any type.

The term “joined” applied to two layers (or aggregations of layers) is to be understood as meaning that these two layers (or aggregations of layers) are made integral with one another so as to form a cohesive unit, either directly or, if the direct mutual interlocking of the two layers (or aggregations of layers) is not possible because of the materials that constitute them respectively, by means of a connection and combination interface layer. One skilled in the art knows which materials can be directly made mutually integral and those that require a connection and combination interface layer and the constituent material of this layer. For this reason, and so as to simplify the description, the latter does not make mention of the possible existence of such a connection and combination interface layer, even if the latter is necessary and provided, with the presence of a suitable connection and combination interface layer then existing and actually implicit and within the grasp of one skilled in the art.

The term “adjacent” applied to two layers (or aggregations of layers) is to be understood as meaning that these two layers (or aggregations of layers) are contiguous—directly or by means of, if necessary, a connection interface.

The superposition of layers that constitute the final multilayer film 7 makes it possible for the latter to fulfill the expected requirements as regards the wall 2 and therefore the pouch 1.

It is known that such a wall 2 is to have a barrier property with a high degree of sealing against gases. From a mechanical standpoint, it is to be able to contain the biopharmaceutical product that is in the pouch 1 and whose volume may be significant. It is also to be able to avoid undesirable interactions with the environment or the biopharmaceutical product, for example during manufacturing, transport or storage. It is to be clean, in particular as regards particles or from the biological standpoint. It is to be non-degradable and to have a high chemical strength. It is also to be able to make it possible that the processing or preservation of the biopharmaceutical product is reliably ensured. It is to be able to be sealed, taking into account the presence of seams 3 and at least one functional element 4. It is to be able to be folded and unfolded easily and without deterioration. It is to have suitable qualities as regards adhesion or flexibility. As appropriate, it is to have a certain transparency, or, in contrast, a certain opacity.

The final multilayer film 7 comprises—and consists of—a monolayer contact film 8 and a multilayer functional film 9.

The monolayer contact film 8 and the multilayer functional film 9 are made integral with one another, in this case by lamination.

More specially, the monolayer contact film 8 will now be described.

The monolayer contact film 8 consists of a material that is selected for having three abilities.

First of all, the selected material is to have the ability to be part of the composition of a final multilayer film 7 that is designed for a wall 2 of pouch 1.

Next, this material is to have the ability to be in contact with the biopharmaceutical product, without degradation of the film 7, 8 and the biopharmaceutical product.

Finally, this material is to have the ability for being sealable on itself, to be able to produce the seams 3.

The contact film 8 is monolayer and consists of this thus selected material.

This constituent material is selected from the family that comprises polyethylene (PE), and in particular linear low-density polyethylene (LLDPE), polyethylene vinyl acetate (EVA), polypropylene (PP), ethylene tetrafluoroethylene (ETFE), polyvinylidene fluoride (PVDF) and the equivalent materials, within the framework of the application that is being considered.

The monolayer contact film 8 has a thickness that is less than the thickness that a single layer would have for contact of a final multilayer film that would be appropriate to the production of seams 3 of the single layer for contact on itself.

For example, in a typical embodiment, the thickness of the monolayer contact film 8 is less than 150 microns.

The monolayer contact film 8 has two surfaces, respectively the surface 10 and the surface 11.

The surface 10 has the function of being an interface for interlocking with a first interface 13 of the multilayer functional film 9.

The surface 11 has as its final function to constitute the contact surface of the final multilayer film 7 and the wall 2 of the pouch 1 with the biopharmaceutical product, i.e., its inside surface 6.

Such a monolayer contact film 8 can be produced by extrusion.

Such a contact film is part of the composition of the final multilayer films 7, in the diversity of the compositions that can be considered. The monolayer contact film 8 is therefore the same, as regards its nature, as all of these films 7. For this reason, the monolayer contact film 8 can be manufactured in a significant quantity by the manufacturers of pouches 1 and under the management of these manufacturers.

More specially, the multilayer functional film 9 will now be described.

First of all, it is understood that the description of functional given to the film 9 does not mean, in contrast, that the monolayer contact film 8 would not have any function. It means only that it is the film 9 that ensures the diversity of the functions sought for the final film 7.

The functional film 9, unlike the monolayer contact film 8, is multilayer.

The multilayer functional film 9 comprises at least one base layer 12, of the same material as the monolayer contact film 8 or of a material that can be joined to that of the monolayer contact film 8 by lamination.

The base layer 12, like the monolayer contact film 8, has a thickness that is less than the thickness that a single contact layer of a final multilayer film would have that would be appropriate for the production of seams 3 of the single contact layer on itself.

For example, in a typical embodiment, the thickness of the base layer 12 is less than 50 microns.

In general, the thickness of the base layer 12 is smaller than that of the contact film 8.

The base layer 12 of the multilayer functional film 9 has two surfaces, respectively the surface 13 and the surface 14.

The surface 13 has as its function to be a first interface for interlocking with the interface 10 of the monolayer contact film 8 (FIG. 2) or with a first interface 15 of another functional multilayer film 9a, with a structure that may or may not be identical (FIGS. 4A, 4B and 4C).

When the surface 13 has as its function to be a first interface for interlocking with the interface 10 of the monolayer contact film 8, the surface 14 has as its function to be a second interface for interlocking with an interface 16 for making the adjacent functional layer 17a integral.

In contrast, the multilayer functional film 9 also comprises at least one layer 17b, that is a barrier against gases and non-degradable, by itself or in combination with a protective layer, with this function always being required.

The multilayer functional film 9 comprises, in addition to the base layer 12, a number of n functional layers 17i, superposed, each made integral with one or both adjacent layers 17h and 17j.

These functional layers 17i are determined and selected for the desired function in the final multilayer film 7. Examples of such functions are flexibility, sturdiness, ability for handling, opacity, or, in contrast, transparency or else biodegradability. This list is only by way of example and is non-limiting.

The constituent materials of the functional layers 17i are selected in such a way as to fulfill the desired function. For example, these materials are selected from the family that comprises polyethylene (PE), and in particular linear low-density polyethylene (LLDPE) or polyethylene terephthalate (PET), a polyamide (PA), polyethylene vinyl acetate (EVA), ethylene vinyl alcohol (EVOH), styrene ethylene butadiene styrene (SEBS), polyethylene terephthalate glycol (PETG . . . ), polyvinylidene fluoride (PVDF) or else aluminum and the equivalent materials, within the framework of the application that is being considered.

The constituent layers of the multilayer functional film 9, namely the base layer 12 and the n functional layers 17i, including the adjacent layer 16a and the gas-barrier layer 17b, are made integral in any suitable manner, depending on the materials that are used, such as co-extrusion or lamination, if necessary with the presence of a suitable connection and combination interface layer.

What is true of functional layers 17i is also true of aggregations of functional layers.

The multilayer functional films 9 can be the object of a wide variety of embodiments, according to the number of functional layers 17i, their natures and their thicknesses.

In the embodiment of FIG. 2, the multilayer functional film 9 comprises the base layer 12 and two functional layers 17a and 17b. Such an embodiment is only by way of example of the inventive concept.

In the embodiment of FIG. 3A, even simpler, the multilayer functional film 9 comprises the base layer 12 and a single functional layer 17a, b.

In the embodiment of FIG. 3B, the multilayer functional film 9 comprises the base layer 12 and three functional layers 17a, 17b and 17c.

In the embodiment of FIG. 3C, the multilayer functional film 9 comprises a first base layer 12, a functional layer 17a, b, and a second base layer 12 that may or may not have the same thickness as the first base layer 12.

In the embodiment of FIG. 3D, the multilayer functional film 9 comprises a first base layer 12, three functional layers 17a, 17b and 17c, and a second base layer 12 that may or may not have the same thickness as the first base layer 12.

In other embodiments, the multilayer functional film 9 is formed by several multilayer functional sub-films 9a, 9b, . . . , each having the structural characteristics of a multilayer functional film such as 9 as has been described above.

Of course, a single layer of those constituent layers of the multilayer functional sub-films 9a, 9b . . . act as a base layer 12, designed to be made integral with the monolayer contact film 8, as has been described above.

The multilayer functional sub-films 9a, 9b are made integral with one another by lamination to form a structural whole.

Thus, it is possible to envision a modular embodiment of the functional films 9, which is advantageous as regards the production process.

In the embodiment of FIG. 4A, the multilayer functional film 9 is formed by two multilayer functional sub-films 9a and 9b. One comprises three layers total, and the other comprises four layers total. These two sub-films 9a and 9b are made integral with one another by the application of two outside layers 12.

In the embodiment of FIG. 4B, the multilayer functional film 9 is formed by three multilayer functional sub-films 9a, 9b, and 9c, comprising five layers for the one 9a that is designed to be joined to the monolayer contact film 8, three layers for the one 9b that is adjacent to it, and four layers for the one 9c that is adjacent to it. As above, the sub-films 9a, 9b, and 9c are made integral with one another by the application of two outside layers 12.

In the embodiment of FIG. 4C, the multilayer functional film 9 is formed by four multilayer functional sub-films 9a, 9b, 9c and 9d, comprising three layers for the one that is designed to be joined to the monolayer contact film 8, also three layers for the one that is adjacent to it, also three layers for the one that is adjacent to it, and two layers for the one that is adjacent to it. As above, the sub-films 9a, 9b, 9c and 9d are made integral with one another by the application of two outside layers 12.

The process for manufacturing a final multilayer film 7 consists in manufacturing or having available a monolayer contact film 8 and a multilayer functional film 9, and then in making them integral by lamination, with one of the surfaces 10 of the monolayer contact film 8 forming an interface being made integral upon contact with the outside surface 13 of the base layer 12 of the multilayer functional film 9.

Several possible embodiments will now be described purely by way of example and not limiting relative to FIGS. 5A to 5J.

In the case of FIG. 5A, the multilayer functional film 9 that is designed to be joined to an LLDPE monolayer film 8 comprises, in addition to and joined to the LLDPE base layer 12:
An EVOH layer
A PA layer
A PET layer that constitutes the outside layer of the multilayer functional film 9 once joined to the LLDPE monolayer film 8.

In the case of FIG. 5B, the multilayer functional film 9 comprises, in addition to and joined to the LLDPE base layer 12, a PE layer.

In the case of FIG. 5C, the multilayer functional film 9 comprises, in addition to and joined to the LLDPE base layer 12:
An EVOH layer
A PA layer
Two LLDPE layers
A layer that is made of biodegradable material (outside layer of the multilayer functional film 9).

In the case of FIG. 5D, the multilayer functional film 9 comprises, in addition to and joined to the LLDPE base layer 12:
A layer made of biodegradable material
Two LLDPE layers
An EVOH layer
A PA layer (outside layer of the multilayer functional film 9).

In the case of FIG. 5E, the multilayer functional film 9 comprises, in addition to and joined to the LLDPE base layer 12, an aluminum layer (outside layer of the multilayer functional film 9).

In the case of FIG. 5F, the multilayer functional film 9 comprises, in addition to and joined to the LLDPE base layer 12:
An aluminum layer
Two LLDPE layers
A PEEK layer (outside layer of the multilayer functional film 9).

In the case of FIG. 5G, the multilayer functional film 9 comprises, in addition to and joined to the PE base layer 12:
An EVA layer
An EVOH layer
An EVA layer
A PE layer (outside layer of the multilayer functional film 9).

In the case of FIG. 5H, the multilayer functional film 9 comprises, in addition to and joined to the LLDPE base layer 12:
An EVOH layer
An LLDPE layer
A PE layer (outside layer of the multilayer functional film 9).

In the case of FIG. 5I, the multilayer functional film 9 comprises, in addition to and joined to the EVA base layer 12:
An EVOH layer
An EVA layer (outside layer of the multilayer functional film 9).

In the case of FIG. 5J, the multilayer functional film 9 comprises, in addition to and joined to the EVA base layer 12:
An EVOH layer
A PE layer (outside layer of the multilayer functional film 9).

An arrangement of a structure for manufacturing a number of final multilayer films 7 of a pouch wall first of all comprises at least one site 18 for manufacturing contact film, in which at least one monolayer contact film 8 is manufactured.

The arrangement next comprises at least one site 19 for manufacturing functional film in which a number of multilayer functional films 9 are manufactured. As appropriate, the films of functional layers 17 are manufactured on the site 19 or else one or more sites 20 for manufacturing films of functional layer 17 are provided, in which functional layers 17 are manufactured from the constituent film.

Such sites 19, 20 comprise one or more units for extrusion, blowing extrusion, co-extrusion, and lamination, whereby these units are implemented depending on requirements.

The sites 18, 19 and 20 can be completely or partly the same or different.

The arrangement also comprises at least one site 21 for making contact film-functional film integral, in which the monolayer contact film 8 that is manufactured in a site 18 and the multilayer functional film 9 that is manufactured in a site 19 are made integral with one another for constituting the final multilayer film 7.

Such sites 21 comprise one or more film lamination units.

The arrangement finally comprises at least one site 22 for manufacturing pouches 1 from the final multilayer film 7.

The sites 21 and 22 can be completely or partly the same or different.

It is advisable to note that the thickness of the monolayer contact film 8 and the base layer 12 of the multilayer functional film 9 can depend on the use targeted by the final multilayer film 7, on the one hand, and parameters adopted for the production of the monolayer contact film 8 and the base layer 12 (material, machine, etc.).

In the event that the monolayer contact film 8 and the base layer 12 of the multilayer functional film 9 are made of PE, it is thus possible to use:
A monolayer contact film 8 that has a thickness of 250 microns and a base layer 12 of the multilayer functional film that has a thickness of 5 microns; or else
A monolayer contact film 8 that has a thickness of 5 microns—which can be produced with PE—and a base layer 12 of the multilayer functional film that has a thickness of 250 microns.

In a similar manner, in the event that the monolayer contact film 8 and the base layer 12 of the multilayer functional film 9 are made of EVA, it is possible to use:
A monolayer contact film 8 that has a thickness of 355 microns and a base layer 12 of the multilayer functional film that has a thickness of 5 microns; or else
A monolayer contact film 8 that has a thickness of 50 microns and a base layer 12 of the multilayer functional film that has a thickness of 310 microns.

1-33. (canceled)

34. Process for manufacturing a final multilayer film (7) of wall (2) of
pouch (1)—with pouch (1) comprising seams (3) at least on itself and designed to be filled with biopharmaceutical product—in which:
On the one hand, a monolayer contact film (8) is manufactured or is available:
And said film consists of a selected material that can:
Be part of the composition of the final multilayer film (7) of a wall (2) of pouch (1),
Be in contact with the biopharmaceutical product, without degradation of the film (7) and the biopharmaceutical product,
Be sealable on itself,
With a thickness that is less than the thickness of a single contact layer of the final multilayer film (7) of a pouch wall that is suitable for the production of seams of the single contact layer on itself,
Of which one of the surfaces has as its function to be an interface for interlocking with a first interface for making the multilayer functional film (9) integral,
Of which the other surface has as its final function to constitute the contact surface of the final multilayer film with the biopharmaceutical product;
On the other hand, a multilayer functional film (9) is manufactured or is available:
And said film comprises at least one base layer (12) of the same material as the monolayer contact film (8) or a material that can be joined to that of the monolayer contact film (8) by lamination,
And with a thickness that is less than the thickness of a single contact layer of the final multilayer film (7) of wall (2) of pouch (1) that is suitable for the production of seams of the single contact layer on itself,
Of which one of the surfaces has as its function to be the first interface for interlocking with the interface for making the monolayer contact film integral or with a first interface of another multilayer functional film (9a) that may or may not have an identical structure,
Of which the other surface has as its function to be a second interface for interlocking with an interface for making an adjacent functional layer integral,
And comprises at least one functional layer including at least one gas-barrier layer that is non-degradable by itself or in combination with a protective layer;
And the monolayer contact film (8) and the multilayer functional film (9) are made integral, with one of the surfaces of the monolayer contact film (8) forming an interface being made integral upon contact with the outside surface of the base layer (12) of the multilayer functional film (9).

35. Process for manufacturing a final multilayer film (7) of wall (2) of pouch (1) according to claim 34, characterized by the fact that a base layer (12) of the same material as that of the monolayer contact film (8) is selected.

36. Process for manufacturing a final multilayer film (7) of wall (2) of pouch (1) according to claim 34, wherein the monolayer contact film (8) and the multilayer functional film (9) are made integral by lamination.

37. Process for manufacturing a final multilayer film (7) of wall (2) of pouch (1) according to claim 34, wherein the final multilayer film (7) comprises a material that is selected to be in contact with the biopharmaceutical product, without degradation of the film and the biopharmaceutical product, and to be sealable on itself, in two laminated layers that belong to the monolayer contact film and the intermediate multilayer film.

38. Process for manufacturing a final multilayer film (7) of wall (2) of pouch (1) according to claim 34, wherein the constituent material of the monolayer contact film (8) is selected from the family that comprises polyethylene (PE) and in particular linear low-density polyethylene (LLDPE), polyethylene vinyl acetate (EVA), polypropylene (PP), ethylene tetrafluoroethylene (ETFE), and polyvinylidene fluoride (PVDF).

39. Process for manufacturing a final multilayer film (7) of wall (2) of pouch (1) according to claim 34, wherein the thickness of the monolayer contact film (8) is less than 150 microns.

40. Process for manufacturing a final multilayer film (7) of wall (2) of pouch (1) according to claim 34, wherein the multilayer functional film (9) comprises a number of superposed functional layers (17a, 17b . . . ), each made integral with the adjacent layer(s).

41. Process for manufacturing a final multilayer film (7) of wall (2) of pouch (1) according to claim 34, wherein the functional layers (17a, 17b . . . ) are selected for their function of flexibility, sturdiness, handling, opacity or, in contrast, transparency.

42. Process for manufacturing a final multilayer film (7) of wall (2) of pouch (1) according to claim 34, wherein the constituent materials of the functional layer(s) are selected from the family that comprises polyethylene (PE), and in particular linear low-density polyethylene (LLDPE) or polyethylene terephthalate (PET), a polyamide (PA), polyethylene vinyl acetate (EVA), ethylene vinyl alcohol (EVOH), styrene ethylene butadiene styrene (SEBS), polyethylene terephthalate glycol (PETG . . . ), polyvinylidene fluoride (PVDF) or else aluminum and the equivalent materials, within the framework of the application that is being considered.

43. Process for manufacturing a final multilayer film (7) of wall (2) of pouch (1) according to claim 34, wherein the layers—or aggregations of layers—of the multilayer functional film (9) are joined, depending on the materials that are used, by co-extrusion or lamination.

44. Process for manufacturing a final multilayer film (7) of wall (2) of pouch (1) according to claim 34, wherein the multilayer functional film (9) is formed by several multilayer functional sub-films (9a, 9b . . . ), each having the structural characteristics of a multilayer functional film (9).

45. Process for manufacturing a final multilayer film (7) of wall (2) of pouch (1) according to claim 34, wherein the multilayer functional film (9) comprises—joined to an LLDPE base layer (12)—an EVOH layer, a PA layer and a PET layer that constitutes the outside layer of the multilayer functional film 9 once joined to the LLDPE monolayer film 8.

46. Process for manufacturing a final multilayer film (7) of wall (2) of pouch (1) according to claim 34, wherein the multilayer functional film (9) comprises—joined to an LLDPE base layer (12)—a PE layer.

47. Process for manufacturing a final multilayer film (7) of wall (2) of pouch (1) according to claim 34, wherein the multilayer functional film (9) comprises—joined to an LLDPE base layer (12)—an EVOH layer, a PA layer, two LLDPE layers, and a layer made of biodegradable material that constitutes the outside layer of the multilayer functional film (9).

48. Process for manufacturing a final multilayer film (7) of wall (2) of pouch (1) according to claim 34, wherein the multilayer functional film (9) comprises—joined to an LLDPE base layer (12)—a layer made of biodegradable material, two LLDPE layers, an EVOH layer, and a PA layer that constitutes the outside layer of the multilayer functional film (9).

49. Process for manufacturing a final multilayer film (7) of wall (2) of pouch (1) according to claim 34, wherein the multilayer functional film (9) comprises—joined to an LLDPE base layer (12)—an aluminum layer that constitutes the outside layer of the multilayer functional film (9).

50. Process for manufacturing a final multilayer film (7) of wall (2) of pouch (1) according to claim 34, wherein the multilayer functional film (9) comprises—joined to an LLDPE base layer (12)—an aluminum layer, two LLDPE layers, and a PEEK layer that constitutes the outside layer of the multilayer functional film (9).

51. Process for manufacturing a final multilayer film (7) of wall (2) of pouch (1) according to claim 34, wherein the multilayer functional film (9) comprises—joined to a PE base layer (12)—an EVA layer, an EVOH layer, an EVA layer, and a PE layer that constitutes the outside layer of the multilayer functional film (9).

52. Process for manufacturing a final multilayer film (7) of wall (2) of pouch (1) according to claim 34, wherein the multilayer functional film (9) comprises—joined to an LLDPE base layer (12)—an EVOH layer, an LLDPE layer, and a PE layer that constitutes the outside layer of the multilayer functional film (9).

53. Monolayer contact film (8), specially designed, once made integral with a multilayer functional film (9), to constitute a final multilayer film (7) of wall (2) of pouch (1)—with pouch (1) comprising seams (3) at least on itself and designed to be filled with biopharmaceutical product:
Composed of a selected material that can:
Be part of the composition of a final multilayer film (7) of a pouch wall,
Be in contact with the biopharmaceutical product, without degradation of the film (7) and the biopharmaceutical product,
Be sealable on itself,
With a thickness that is less than the thickness of a single contact layer of a pouch wall that is suitable for the production of seams of the single contact layer on itself,
Of which one of the surfaces has as its function to be an interface for interlocking with a first interface for making the multilayer functional film (9) integral,
Of which the other surface has as its final function to constitute the contact surface of the final multilayer film with the biopharmaceutical product.

54. Multilayer functional film (9), specially designed, once made integral with a monolayer contact film (8) according to claim 53, to constitute a final multilayer film (7) of wall (2) of pouch (1)—with pouch (1) comprising seams (3) at least on itself and designed to be filled with biopharmaceutical product:
Comprising at least one base layer (12) of the same material as the monolayer contact film (8) and with a thickness that is less than the thickness of a single contact layer of a suitable pouch wall in addition to the production of seams of the single contact layer on itself,
Of which one of the surfaces has as its function to be the first interface for interlocking with the interface for making the monolayer contact film integral or with a first interface of another multilayer functional film (9a) that may or may not have an identical structure,
Of which the other surface has as its function to be a second interface for interlocking with an interface for making an adjacent functional layer integral,
And comprising at least one functional layer including at least one gas-barrier layer that is non-degradable by itself or in combination with a protective layer.

55. Final multilayer film (7) of wall (2) of pouch (1)—with pouch (1) comprising seams (3) at least on itself and designed to be filled with biopharmaceutical product—comprising:
A monolayer contact film (8) specially designed, once made integral with a multilayer functional film (9), to constitute a final multilayer film (7) of wall (2) of pouch (1)—with pouch (1) comprising seams (3) at least on itself and designed to be filled with biopharmaceutical product:
Composed of a selected material that can:
Be part of the composition of a final multilayer film (7) of a pouch wall,
Be in contact with the biopharmaceutical product, without degradation of the film (7) and the biopharmaceutical product,
Be sealable on itself,
With a thickness that is less than the thickness of a single contact layer of a pouch wall that is suitable for the production of seams of the single contact layer on itself,
Of which one of the surfaces has as its function to be an interface for interlocking with a first interface for making the multilayer functional film (9) integral,
Of which the other surface has as its final function to constitute the contact surface of the final multilayer film with the biopharmaceutical product,
A multilayer functional film (9) according to claim 54,
With the monolayer contact film (8) and the multilayer functional film (9) being made integral with one another.

56. Pouch (1) of the type that comprises a wall (2) that forms an envelope and seams (3) at least on itself, designed to be filled with biopharmaceutical product, wherein the wall (2) is a final multilayer film (7) of a pouch wall according to claim 55.

57. Arrangement of a structure for manufacturing a number of final multilayer films (7) with a wall (2) of pouch (1) according to claim 55, wherein it comprises:
At least one site (18) for manufacturing contact film, in which at least one monolayer contact film (8) is manufactured,
At least one site (19) for manufacturing functional film, in which a number of multilayer functional films (9) are manufactured,
At least one site (21) for making contact film-functional film integral, in which the monolayer contact film (8) that is manufactured in a site for manufacturing contact film (18) and the multilayer functional film (9) that is manufactured in a site (19) for manufacturing functional film are made integral with one another.
